(19) United States
(12) Patent Application Publication
(10) Pub. No.: US 2023/0155753 A1
(43) Pub. Date: May 18, 2023

(54) TECHNIQUES FOR UPDATING DEFAULT BEAMS AND PATHLOSS REFERENCE SIGNALS IN A MULTI-COMPONENT CARRIER COMMUNICATION LINK

(71) Applicant: QUALCOMM Incorporated, San Diego, CA (US)

(72) Inventors: Yan ZHOU, San Diego, CA (US); Fang YUAN, Beijing (CN); Mostafa KHOSHNEVISAN, San Diego, CA (US); Tao LUO, San Diego, CA (US)

(21) Appl. No.: 17/995,646

(22) PCT Filed: Jun. 5, 2020
(86) PCT No.: PCT/CN2020/094508

§ 371 Date: Oct. 6, 2022

(51) Int. Cl. H04L 5/00; H04B 7/06

(52) U.S. Cl. CPC H04L 5/001; H04B 7/0695; H04L 5/0053; H04L 5/0048; H04L 5/0092

(57) ABSTRACT

Various aspects of the present disclosure generally relate to wireless communication. In some aspects, a user equipment may determine one or more of a default uplink beam or a default pathloss reference signal (PL RS) for a first component carrier of a communication link; and apply the one or more of the default uplink beam or the default PL RS to a second component carrier of the communication link based at least in part on the UE not receiving an indication of a spatial relation for the second component carrier or an indication of a PL RS for the second component carrier. Numerous other aspects are provided.

### FIELD OF THE DISCLOSURE

Aspects of the present disclosure generally relate to wireless communication and to techniques and apparatuses for updating default beams and pathloss reference signals in a multi-component carrier communication link.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmission and reception point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a user equipment, may include determining one or more of a default uplink beam or a default pathloss reference signal (PL RS) for a first component carrier of a communication link; and applying the one or more of the default uplink beam or the default PL RS to a second component carrier of the communication link based at least in part on the second component carrier having no currently indicated PL RS or spatial relation.

In some aspects, application of the one or more of the default uplink beam or the default PL RS to the second component carrier of the communication link is based at least in part on the second component carrier being indicated within an uplink component carrier list that indicates to apply the one or more of the default uplink beam or the PL RS to the second component carrier of the communication link.

In some aspects, determination of the one or more of the default uplink beam or the default PL RS for the first component carrier of the communication link includes one or more of determining the one or more of the default uplink beam or the default PL RS for the first component carrier of the communication link based at least in part on a first reference signal associated with a control resource set (CORESET) of a lowest CORESET ID, or determining the one or more of the default uplink beam or the default PL RS for the first component carrier of the communication link based at least in part on a second reference signal associated with an active PDSCH.

In some aspects, the first reference signal includes a quasi-co-location (QCL) TypeD reference signal of a first transmission configuration indicator (TCI) or QCL of a CORESET that has a lowest CORESET ID, or the second reference signal comprises a QCL TypeD reference signal of a second TCI or QCL of an active PDSCH TCI ID.

In some aspects, the method includes receiving a first update, for multiple component carriers in a downlink component carrier list, for the first TCI or QCL of a CORESET that has the lowest CORESET ID, or receiving a second update, for the multiple component carriers in the downlink component carrier list, for the second TCI or QCL of the active PDSCH TCI ID.

In some aspects, reception of the first update includes receiving the first update via a first medium access control element (MAC CE), or reception of the second update includes receiving the second update via a second MAC CE.

In some aspects, the method includes determining one or more of an updated uplink beam or an updated PL RS for multiple component carriers in an uplink component carrier list based at least in part on an updated TCI or QCL, for a single component carrier of the multiple component carriers in a downlink component carrier list.

In some aspects, the single component carrier of the multiple component carriers in the downlink component carrier list includes a component carrier having a lowest component carrier (CC) ID of component carriers that are in both of the downlink component carrier list and the uplink component carrier list, a component carrier having a highest CC ID of component carriers that are in both of the downlink component carrier list and the uplink component carrier list, or a designated component carrier of component carriers that are in both of the downlink component carrier list and the uplink component carrier list.

In some aspects, the method includes receiving an indication of the single component carrier via radio resource control (RRC) signaling, one or more MAC CEs, or downlink control information (DCI).

In some aspects, the method includes receiving an indication of the default uplink beam or the default PL RS for the first component carrier via a MAC CE, wherein the default uplink beam or the default PL RS is associated with a sounding reference signal (SRS) resource; and transmitting one or more SRSs based at least in part on applying the default uplink beam or the default PL RS to multiple component carriers including the second component carrier.

In some aspects, the communication link includes a multiple TRP communication link with a multiple DCI configuration or a single DCI configuration, and application of the one or more of the default uplink beam or the default PL RS to a second component carrier is based at least in part on the first component carrier and the second component carrier being associated with a same TRP.

In some aspects, determination of the one or more of the default uplink beam or the default PL RS for the first component carrier of the communication link includes one or more of: determining the one or more of the default uplink beam or the default PL RS for the first component carrier of the communication link based at least in part on a first QCL TypeD reference signal of a first TCI or QCL of a CORESET that has a lowest CORESET ID of component carriers associated with the same TRP, or determining the one or more of the default uplink beam or the default PL RS for the first component carrier of the communication link based at least in part on a second QCL TypeD reference signal of a second TCI or QCL of an active PDSCH TCI ID associated with the same TRP.

In some aspects, the communication link includes the single DCI configuration, and determination of the one or more of the default uplink beam or the default PL RS for the first component carrier includes determining the one or more of the default uplink beam or the default PL RS for the first component carrier based at least in part on a QCL TypeD reference signal of a single TCI state of multiple TCI states that are mapped to a same TCI codepoint.

In some aspects, the TCI codepoint of the single TCI state is mapped with multiple TCI states and includes a lowest TCI codepoint ID among TCI codepoints mapped to the multiple TCI states, a highest TCI codepoint among the TCI codepoints mapped to the multiple TCI states, or a designated TCI codepoint of the TCI codepoints mapped to the multiple TCI states.

In some aspects, the method includes determining one or more of an updated uplink beam or an updated PL RS for the same TRP for multiple component carriers associated with the same TRP in an uplink component list, and determining that the multiple component carriers are associated with the same TRP based at least in part on having a same CORESET pool index or a same TCI state order in a TCI codepoint.

In some aspects, the method includes determining a default downlink beam per TRP based at least in part on a TCI or QCL of a CORESET of a lowest CORESET ID, of the same TRP, in a most recently monitored slot, wherein the communication is linking includes a multiple DCI configuration.

In some aspects, the method includes determining a default downlink beam per TRP based at least in part on a single TCI state of multiple TCI states that are mapped to a same TCI codepoint that has a lowest TCI codepoint ID among TCI codepoints mapped to multiple TCI states.

In some aspects, the method includes determining one or more of an updated uplink beam or an updated PL RS for the same TRP for multiple component carriers associated with the same TRP in a downlink component list, and determining that the multiple component carriers are associated with the same TRP based at least in part on having a same CORESET pool index or a same TCI state order in a codepoint.

In some aspects, a user equipment for wireless communication may include a memory and one or more processors operatively coupled to the memory. The memory and the one or more processors may be configured to determine one or more of a default uplink beam or a default PL RS for a first component carrier of a communication link; and apply the one or more of the default uplink beam or the default PL RS to a second component carrier of the communication link based at least in part on the second component carrier having no currently indicated PL RS or spatial relation.

In some aspects, application of the one or more of the default uplink beam or the default PL RS to the second component carrier of the communication link is based at least in part on the second component carrier being indicated within an uplink component carrier list that indicates to apply the one or more of the default uplink beam or the PL RS to the second component carrier of the communication link.

In some aspects, determination of the one or more of the default uplink beam or the default PL RS for the first component carrier of the communication link includes one or more of determining the one or more of the default uplink beam or the default PL RS for the first component carrier of the communication link based at least in part on a first reference signal associated with a CORESET of the lowest CORESET ID, or determining the one or more of the default uplink beam or the default PL RS for the first component carrier of the communication link based at least in part on a second reference signal associated with an active PDSCH TCI ID.

In some aspects, the first reference signal includes a QCL TypeD reference signal of a first TCI or QCL of a CORESET that has a lowest CORESET ID, or the second reference signal comprises a QCL TypeD reference signal of a second TCI or QCL of an active PDSCH TCI ID.

In some aspects, the one or more processors are further configured to receive a first update, for multiple component carriers in a downlink component carrier list, for the first TCI or QCL of a CORESET that has the lowest CORESET ID, or receive a second update, for the multiple component carriers in the downlink component carrier list, for the second TCI or QCL of the active PDSCH TCI ID.

In some aspects, reception of the first update includes reception of the first update via a first MAC CE, or reception of the second update includes reception of the second update via a second MAC CE.

In some aspects, the one or more processors are further configured to determine one or more of an updated uplink beam or an updated PL RS for multiple component carriers in an uplink component carrier list based at least in part on an updated TCI or QCL for a single component carrier of the multiple component carriers in a downlink component carrier list.

In some aspects, the single component carrier of the multiple component carriers in the downlink component carrier list includes a component carrier having a lowest CORESET ID of component carriers that are in both of the downlink component carrier list and the uplink component carrier list, a component carrier having a highest CORESET ID of component carriers that are in both of the downlink component carrier list and the uplink component carrier list, or a designated component of component carriers that are in both of the downlink component carrier list and the uplink component carrier list.

In some aspects, the one or more processors are further configured to receive an indication of the single component carrier via RRC signaling, one or more MAC CEs, or DCI.

In some aspects, the one or more processors are further configured to receive an indication of the default uplink beam or the default PL RS for the first component carrier via a MAC CE, wherein the default uplink beam or the default PL RS is associated with an SRS resource; and transmit one or more SRSs based at least in part on applying the default uplink beam or the default PL RS to multiple component carriers including the second component carrier.

In some aspects, the communication link includes a multiple TRP communication link with a multiple DCI configuration or a single DCI configuration, and application of the one or more of the default uplink beam or the default PL RS to a second component carrier is based at least in part on the first component carrier and the second component carrier being associated with a same TRP.

In some aspects, determination of the one or more of the default uplink beam or the default PL RS for the first component carrier of the communication link includes one or more of: a determination of the one or more of the default uplink beam or the default PL RS for the first component carrier of the communication link based at least in part on a first QCL TypeD reference signal of a first TCI or QCL of a CORESET that has a lowest CORESET ID of component carriers associated with the same TRP, or a determination of the one or more of the default uplink beam or the default PL RS for the first component carrier of the communication link based at least in part on a second QCL TypeD reference signal of a second TCI or QCL of an active PDSCH TCI ID associated with the same TRP.

In some aspects, the communication link includes the single DCI configuration, and determination of the one or more of the default uplink beam or the default PL RS for the first component carrier includes determining the one or more of the default uplink beam or the default PL RS for the first component carrier based at least in part on a QCL TypeD reference signal of a single TCI state of multiple TCI states that are mapped to a same TCI codepoint.

In some aspects, the TCI codepoint of the single TCI state is mapped to multiple TCI states and includes a lowest TCI codepoint ID among TCI codepoints mapped to the multiple TCI states, a highest TCI codepoint among the TCI codepoints mapped to the multiple TCI states, or a designated TCI codepoint of the TCI codepoints mapped to the multiple TCI states.

In some aspects, the one or more processors are further configured to determine one or more of an updated uplink beam or an updated PL RS for the same TRP for multiple component carriers associated with the same TRP in an uplink component list, and determine that the multiple component carriers are associated with the same TRP based at least in part on having a same CORESET pool index or a same TCI state order in a codepoint.

In some aspects, the one or more processors are further configured to determine a default downlink beam per TRP based at least in part on a TCI or QCL of a CORESET of the lowest CORESET ID, of the same TRP, in a most recently monitored slot, wherein the communication is linking includes a multiple DCI configuration.

In some aspects, the one or more processors are further configured to determine a default downlink beam per TRP based at least in part on a single TCI state of multiple TCI states that are mapped to a same TCI codepoint that has a lowest TCI codepoint ID among TCI codepoints mapped to multiple TCI states.

In some aspects, the one or more processors are further configured to determine one or more of an updated uplink beam or an updated PL RS for the same TRP for multiple component carriers associated with the same TRP in a downlink component list, and determine that the multiple component carriers are associated with the same TRP based at least in part on having a same CORESET pool index or a same TCI state order in a codepoint.

In some aspects, a non-transitory computer-readable medium may store one or more instructions for wireless communication. The one or more instructions, when executed by one or more processors of a UE, may cause the one or more processors to determine one or more of a default uplink beam or a default PL RS for a first component carrier of a communication link; and apply the one or more of the default uplink beam or the default PL RS to a second component carrier of the communication link based at least in part on the second component carrier having no currently indicated PL RS or spatial relation.

In some aspects, application of the one or more of the default uplink beam or the default PL RS to the second component carrier of the communication link is based at least in part on the second component carrier being indicated within an uplink component carrier list that indicates to apply the one or more of the default uplink beam or the PL RS to the second component carrier of the communication link.

In some aspects, determination of the one or more of the default uplink beam or the default PL RS for the first component carrier of the communication link includes one or more of determining the one or more of the default uplink beam or the default PL RS for the first component carrier of the communication link based at least in part on a first reference signal associated with a CORESET of the lowest CORESET ID, or determining the one or more of the default uplink beam or the default PL RS for the first component carrier of the communication link based at least in part on a second reference signal associated with an active PDSCH TCI ID.

In some aspects, the first reference signal includes a QCL TypeD reference signal of a first TCI or QCL of CORESET that has a lowest CORESET ID, or the second reference signal comprises a QCL TypeD reference signal of a second TCI or QCL of an active PDSCH TCI ID.

In some aspects, the one or more instructions, when executed by the one or more processors, further cause the one or more processors to receive a first update, for multiple component carriers in a downlink component carrier list, for the first TCI or QCL of a CORESET that has the lowest CORESET ID, or receive a second update, for the multiple component carriers in the downlink component carrier list, for the second TCI or QCL of the active PDSCH TCI ID.

In some aspects, reception of the first update includes reception of the first update via a first MAC CE, or reception of the second update includes reception of the second update via a second MAC CE.

In some aspects, the one or more instructions, when executed by the one or more processors, further cause the one or more processors to determine one or more of an updated uplink beam or an updated PL RS for multiple component carriers in an uplink component carrier list based at least in part on an updated TCI or QCL for a single component carrier of the multiple component carriers in a downlink component carrier list.

In some aspects, the single component carrier of the multiple component carriers in the downlink component carrier list includes a component carrier having a lowest CORESET ID of component carriers that are in both of the downlink component carrier list and the uplink component carrier list, a component carrier having a highest CORESET ID of component carriers that are in both of the downlink component carrier list and the uplink component carrier list, or a designated component of component carriers that are in both of the downlink component carrier list and the uplink component carrier list.

In some aspects, the one or more instructions, when executed by the one or more processors, further cause the one or more processors to receive an indication of the single component carrier via RRC signaling, one or more MAC CEs, or DCI.

In some aspects, the one or more instructions, when executed by the one or more processors, further cause the one or more processors to receive an indication of the default uplink beam or the default PL RS for the first component carrier via a MAC CE, wherein the default uplink beam or the default PL RS is associated with an SRS resource; and transmit one or more SRSs based at least in part on applying the default uplink beam or the default PL RS to multiple component carriers including the second component carrier.

In some aspects, the communication link includes a multiple TRP communication link with a multiple DCI configuration or a single DCI configuration, and application of the one or more of the default uplink beam or the default PL RS to a second component carrier is based at least in part on the first component carrier and the second component carrier being associated with a same TRP.

In some aspects, determination of the one or more of the default uplink beam or the default PL RS for the first component carrier of the communication link includes one or more of: a determination of the one or more of the default uplink beam or the default PL RS for the first component carrier of the communication link based at least in part on a first QCL TypeD reference signal of a first TCI or QCL of CORESET that has a lowest CORESET ID of component carriers associated with the same TRP, or a determination of the one or more of the default uplink beam or the default PL RS for the first component carrier of the communication link based at least in part on a second QCL TypeD reference signal of a second TCI or QCL of an active PDSCH TCI ID associated with the same TRP.

In some aspects, the communication link includes the single DCI configuration, and determination of the one or more of the default uplink beam or the default PL RS for the first component carrier includes determining the one or more of the default uplink beam or the default PL RS for the first component carrier based at least in part on a QCL TypeD reference signal of a single TCI state of multiple TCI states that are mapped to a same TCI codepoint.

In some aspects, the TCI codepoint of the single TCI state is mapped to multiple TCI states and includes a lowest TCI codepoint ID among TCI codepoints mapped to the multiple TCI states, a highest ICI codepoint among the TCI codepoints mapped to the multiple TCI states, or a designated To codepoint of the TCI codepoints mapped to the multiple TCI states.

In some aspects, the one or more processors are further configured to determine one or more of an updated uplink beam or an updated PL RS for the same TRP for multiple component carriers associated with the same TRP in an uplink component list, and determine that the multiple component carriers are associated with the same TRP based at least in part on having a same CORESET pool index or a same TCI state order in a TCI codepoint.

In some aspects, the one or more instructions, when executed by the one or more processors, further cause the one or more processors to determine a default downlink beam per TRP based at least in part on a TCI or QCL of a CORESET of the lowest CORESET ID, of the same TRP, in a most recently monitored slot, wherein the communication is linking includes a multiple DCI configuration.

In some aspects, the one or more instructions, when executed by the one or more processors, further cause the one or more processors to determine a default downlink beam per TRP based at least in part on a single TCI state of multiple TCI states that are mapped to a same TCI codepoint that has a lowest TCI codepoint ID among TCI codepoints mapped to multiple TCI states.

In some aspects, the one or more instructions, when executed by the one or more processors, further cause the one or more processors to determine one or more of an updated uplink beam or an updated PL RS for the same TRP for multiple component carriers associated with the same TRP in a downlink component list, and determine that the multiple component carriers are associated with the same TRP based at least in part on having a same CORESET pool index or a same TCI state order in a codepoint.

In some aspects, an apparatus for wireless communication may include means for determining one or more of a default uplink beam or a default PL RS for a first component carrier of a communication link; and means for applying the one or more of the default uplink beam or the default PL RS to a second component carrier of the communication link based at least in part on the second component carrier having no currently indicated PL RS or spatial relation.

In some aspects, application of the one or more of the default uplink beam or the default PL RS to the second component carrier of the communication link is based at least in part on the second component carrier being indicated within an uplink component carrier list that indicates to apply the one or more of the default uplink beam or the PL RS to the second component carrier of the communication link.

In some aspects, determination of the one or more of the default uplink beam or the default PL RS for the first component carrier of the communication link includes one or more of determining the one or more of the default uplink beam or the default PL RS for the first component carrier of the communication link based at least in part on a first reference signal associated with a CORESET of the lowest CORESET ID, or determining the one or more of the default uplink beam or the default PL RS for the first component carrier of the communication link based at least in part on a second reference signal associated with an active PDSCH TCI ID.

In some aspects, the first reference signal includes a QCL TypeD reference signal of a first TCI or QCL of a CORESET that has a lowest CORESET ID, or the second reference signal comprises a QCL TypeD reference signal of a second TCI or QCL of an active PDSCH TCI ID.

In some aspects, the apparatus includes means for receiving a first update, for multiple component carriers in a downlink component carrier list, for the first TCI or QCL of a CORESET that has the lowest CORESET ID, or receiving a second update, for the multiple component carriers in the downlink component carrier list, for the second TCI or QCL of the active PDSCH TCI ID.

In some aspects, reception of the first update includes receiving the first update via a first MAC CE, or reception of the second update includes receiving the second update via a second MAC CE.

In some aspects, the apparatus includes means for determining one or more of an updated uplink beam or an updated PL RS for multiple component carriers in an uplink component carrier list based at least in part on an updated TCI or QCL for a single component carrier of the multiple component carriers in a downlink component carrier list.

In some aspects, the single component carrier of the multiple component carriers in the downlink component carrier list includes a component carrier having a lowest CORESET ID of component carriers that are in both of the downlink component carrier list and the uplink component carrier list, a component carrier having a highest CORESET ID of component carriers that are in both of the downlink component carrier list and the uplink component carrier list, or a designated component of component carriers that are in both of the downlink component carrier list and the uplink component carrier list.

In some aspects, the apparatus includes means for receiving an indication of the single component carrier via RRC signaling, one or more MAC CEs, or DCI.

In some aspects, the apparatus includes means for receiving an indication of the default uplink beam or the default PL RS for the first component carrier via a MAC CE, wherein the default uplink beam or the default PL RS is associated with an SRS resource; and transmitting one or more SRSs based at least in part on applying the default uplink beam or the default PL RS to multiple component carriers including the second component carrier.

In some aspects, the communication link includes a multiple TRP communication link with a multiple DCI configuration or a single DCI configuration, and application of the one or more of the default uplink beam or the default PL RS to a second component carrier is based at least in part on the first component carrier and the second component carrier being associated with a same TRP.

In some aspects, determination of the one or more of the default uplink beam or the default PL RS for the first component carrier of the communication link includes one or more of: determining the one or more of the default uplink beam or the default PL RS for the first component carrier of the communication link based at least in part on a first QCL TypeD reference signal of a first TCI or QCL of a CORESET that has a lowest CORESET ID of component carriers associated with the same TRP, or determining the one or more of the default uplink beam or the default PL RS for the first component carrier of the communication link based at least in part on a second QCL TypeD reference signal of a second TCI or QCL of an active PDSCH TCI ID associated with the same TRP.

In some aspects, the communication link includes the single DCI configuration, and determination of the one or more of the default uplink beam or the default PL RS for the first component carrier includes determining the one or more of the default uplink beam or the default PL RS for the first component carrier based at least in part on a QCL TypeD reference signal of a single TCI state of multiple TCI states that are mapped to a same TCI codepoint.

In some aspects, the TCI codepoint of the single TCI state is mapped to multiple TCI states and includes a lowest TCI codepoint ID among TCI codepoints mapped to the multiple TCI states, a highest TCI codepoint ID among the TCI codepoints mapped to the multiple TCI states, or a designated TCI codepoint of the TCI codepoints mapped to the multiple TCI states.

In some aspects, the apparatus includes means for determining one or more of an updated uplink beam or an updated PL RS for the same TRP for multiple component carriers associated with the same TRP in an uplink component list, and determining that the multiple component carriers are associated with the same TRP based at least in part on having a same CORESET pool index or a same TCI state order in a codepoint.

In some aspects, the apparatus includes means for determining a default downlink beam per TRP based at least in part on a TCI or QCL, of a CORESET of the lowest CORESET ID, of the same TRP, in a most recently monitored slot, wherein the communication is linking includes a multiple DCI configuration.

In some aspects, the apparatus includes means for determining a default downlink beam per TRP based at least in part on a single TCI state of multiple TCI states that are mapped to a same TCI codepoint that has a lowest TCI codepoint ID among TCI codepoints mapped to multiple TCI states.

In some aspects, the apparatus includes means for determining one or more of an updated uplink beam or an updated PL RS for the same TRP for multiple component carriers associated with the same TRP in a downlink component list, and determining that the multiple component carriers are associated with the same TRP based at least in part on having a same CORESET pool index or a same TCI state order in a codepoint.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of scheduling an uplink or downlink signal using downlink control information in a control resource set, in accordance with various aspects of the present disclosure.

FIGS. 4-7 are diagrams illustrating examples associated with updating default beams and pathloss reference signals in a multi-component carrier communication link, in accordance with various aspects of the present disclosure.

FIG. 8 is a diagram illustrating an example process associated with updating default beams and pathloss reference signals in a multi-component carrier communication link, in accordance with various aspects of the present disclosure.

FIG. 9 is a block diagram of an example apparatus for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technologies (RAT), aspects of the present disclosure can be applied to other RATs, such as a 3G RAT, a 4G RAT, and/or a RAT subsequent to 5G (e.g., 6G).

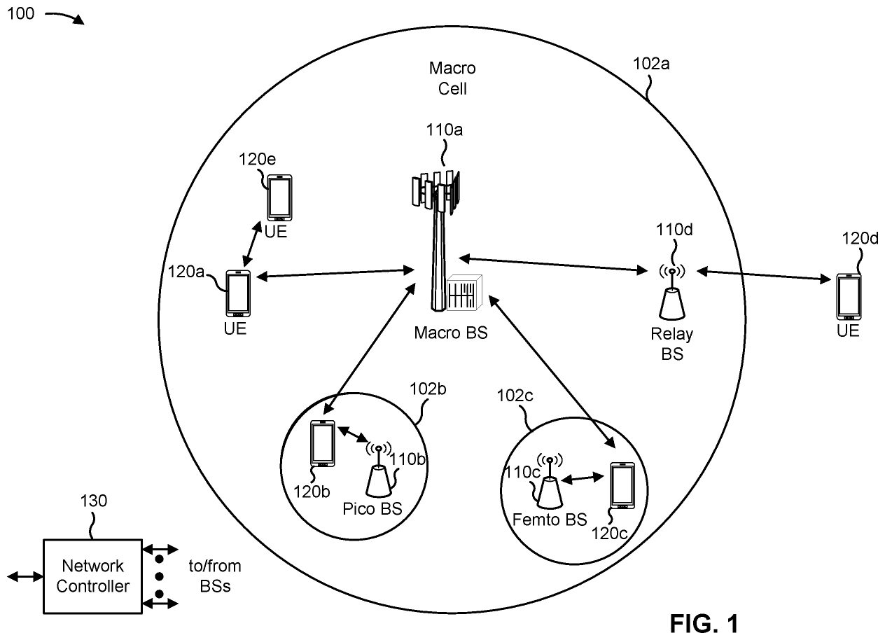

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmission and reception point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pica cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a LIE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul, The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC;) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GEL-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example, Other examples may differ from what is described with regard to FIG. 1.

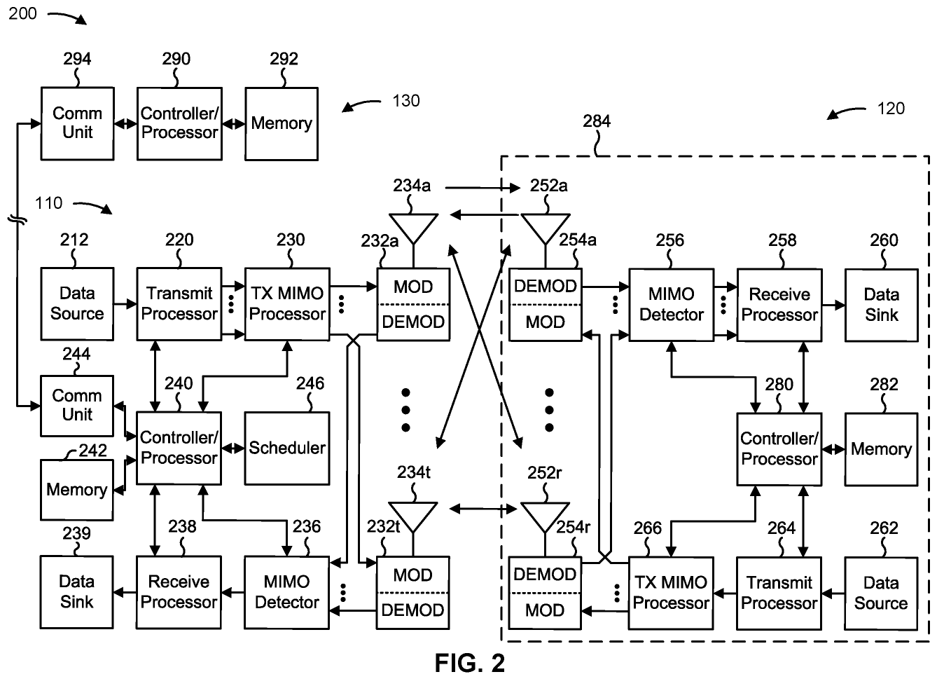

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQLs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODS) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

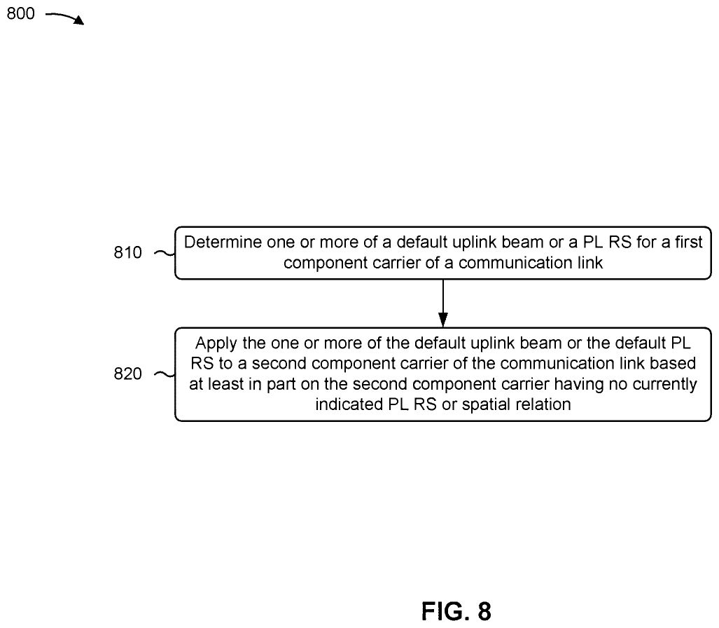

Controller/processor 240 of base station 110, controller/processor 280 of UE 120, and/or any other component(s) of FIG. 2 may perform one or more techniques associated with updating default beams and pathloss reference signals in a multi-component carrier communication link, as described in more detail elsewhere herein. For example, controller/processor 240 of base station 110, controller/processor 280 of UE 120, and/or any other component(s) of FIG. 2 may perform or direct operations of, for example, process 800 of FIG. 8 and/or other processes as described herein. Memories 242 and 282 may store data and program codes for base station 110 and UE 120, respectively. In some aspects, memory 242 and/or memory 282 may include a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 800 of FIG. 8 and/or other processes as described herein. In some aspects, executing instructions may include running the instructions, converting the instructions, compiling the instructions, interpreting the instructions, and/or the like.

In some aspects, UE 120 may include means for determining one or more of a default uplink beam or a default PL RS for a first component carrier of a communication link; means for applying the one or more of the default uplink beam or the default PL RS to a second component carrier of the communication link based at least in part on the second component carrier having no currently indicated PL RS or spatial relation; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

As indicated above, FIG. 2 is provided as an example. Other examples may differ from what is described with regard to FIG. 2.

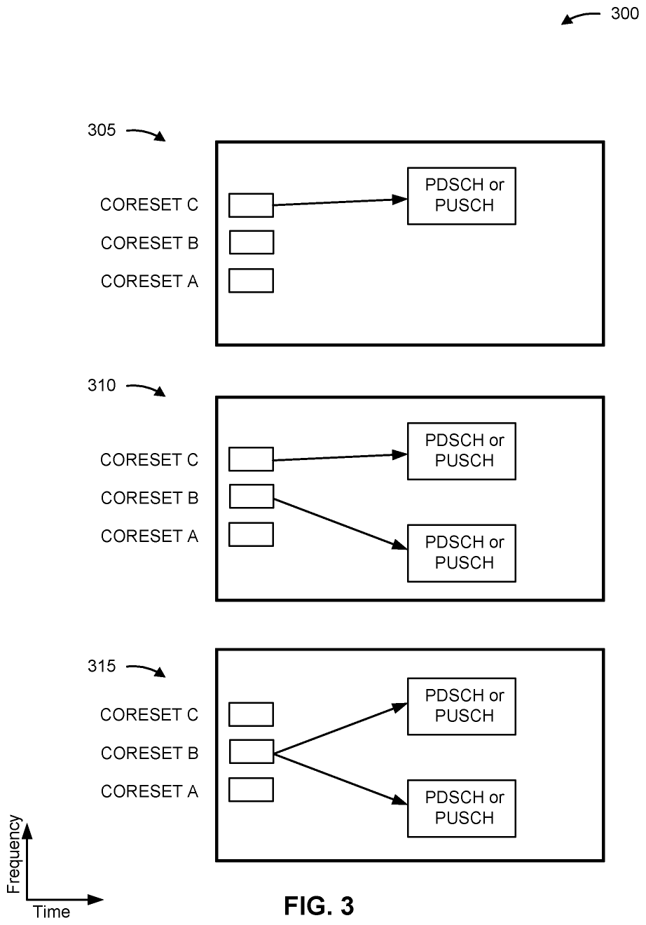

FIG. 3 is a diagram illustrating an example of scheduling an uplink or downlink signal using downlink control information in a control resource set, in accordance with various aspects of the present disclosure. In some aspects, a UE may receive a resource grant for an uplink (e.g., a physical uplink shared channel (PUSCH)) communication, a downlink (e.g., a physical downlink shared channel (PDSCH)) communication, and/or the like for communicating with a base station. In some aspects, the base station, a TRP, and/or the like may transmit the resource grant to the UE as downlink control information (DCI) within one or more control resource sets (CORESETs).

As shown by reference number 305, the UE may receive a single DCI message within a single CORESET that schedules a single communication via the PDSCH or the PUSCH. As shown by reference number 310, the UE may receive multiple DCI messages within multiple CORESETs that schedule multiple communications via the PUSCH or the PUSCH.

As shown by reference number 315, the UE may receive a single DCI message within a single CORESET that schedules multiple communications via the PDSCH or the PUSCH. In some aspects, an indication of the single DCI may be associated with a TCI codepoint that maps to a single TCI state or multiple TCI states. For example, a TCI codepoint0 may map to a TCI A0, a TCI codepoint1 may map to a TCI B1, a TCI codepoint2 may map to both of a TCI C0 and a TCI C1 (e.g., when the single DCI message schedules multiple communications).

As indicated above, FIG. 3 is provided as an example. Other examples may differ from what is described with regard to FIG. 3.

The UE may need to determine a beam and/or transmission power control parameters to use for transmitting a SRS, a PUSCH communication, a physical uplink control channel (PUCCH) communication, and/or the like. The UE may receive information for determining the beam and/or transmission power control parameters for one or more component carriers used to communicate with the base station.

The UE may be configured to individually determine a default uplink beam and/or a default PL RS for each SRS, PUSCH, and/or PUCCH communication and/or to receive an explicit indication of a component carrier to which an indicated spatial relation applies. This may require unnecessary overhead, which may consume computing, communication, and/or network resources for the UE to receive and/or apply.

In some aspects described herein, a UE may determine a default uplink beam and/or a default PL RS for one component carrier and apply the default uplink beam and/or the default PL RS to multiple component carriers (e.g., the one component carrier and at least one additional component carrier) in an uplink component carrier list. In some aspects, the UE may determine the default uplink beam and/or the default PL RS based at least in part on a reference signal (e.g., a QCL-TypeD reference signal) of a TCI and/or QCL of a CORESET of the lowest CORESET ID or, if there is not a configured CORESET, an active PDSCH TCI ID.

In some aspects, a TCI and/or QCL of a CORESET of the lowest CORESET ID or an active PDSCH TCI ID may be simultaneously updated by one MAC CE for multiple component carriers in a downlink component carrier list. In some aspects, simultaneous physical downlink control channel (PDCCH) and/or PDSCH beam updates across multiple component carriers may not be allowed. In some aspects where the simultaneous beam updates across multiple component carriers is allowed, the UE may determine an updated default uplink beam and/or PL RS for multiple component carriers in an uplink component carrier list based at least in part on a QCL-TypeD reference signal of an updated TCI and/or QCL of a CORESET of the lowest CORESET ID or an active PDSCH TCI ID for one component carrier. The one component carrier may have a highest component carrier ID, a lowest component carrier ID, or a special (e.g., associated with an indication) component carrier ID among component carriers that belong to both of the downlink component carrier list and the uplink component carrier list or one that is explicitly indicated via RRC signaling, a MAC CE, DCI, and/or the like.

In this way, the UE may determine one default beam and/or PL RS to apply to multiple component carriers to conserve computing, communication, and/or networking resources that may otherwise have been used to receive additional signaling from a base station, separately determine the default beams and/or PL RSs for each component carrier, and/or the like.

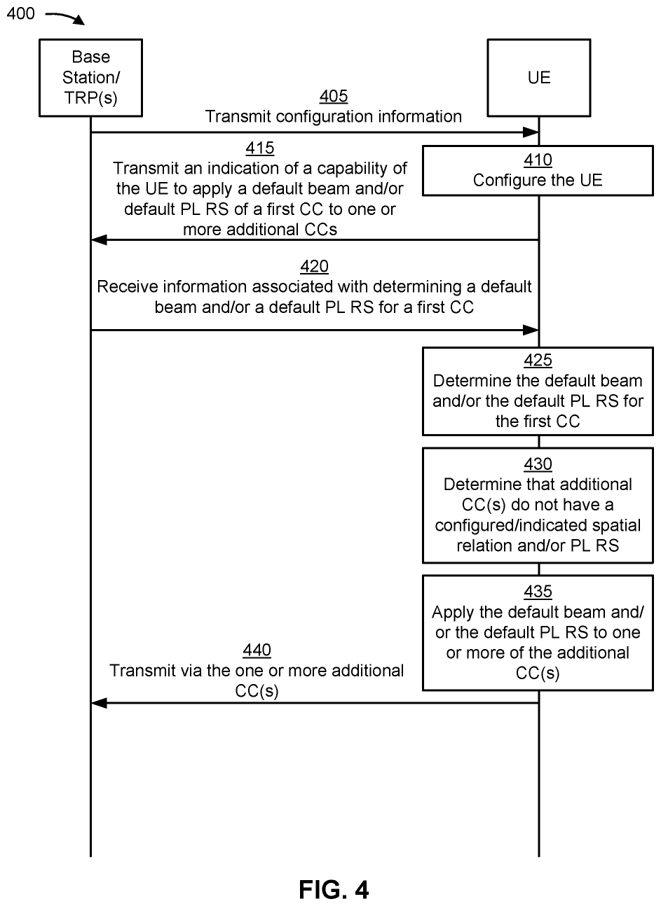

FIGS. 4-7 are diagrams illustrating examples 400, 500, 600, and 700 associated with updating default beams and PL RSs in a multi-component carrier communication link, in accordance with various aspects of the present disclosure.

As shown in FIG. 4, a UE (e.g., UE 120) may communicate (e.g., transmit an uplink transmission and/or receive a downlink transmission) with a base station (e.g., base station 110), The UE and the base station may be part of a wireless network (e.g., wireless network 100).

As shown by reference number 405, the base station may transmit, and the UE may receive, configuration information. In some aspects, the UE may receive configuration information from another device (e.g., from another base station, another UE, and/or the like). In some aspects, the UE may receive the configuration information via one or more of RRC signaling, medium access control (MAC) signaling (e.g., MAC CEs), and/or the like. In some aspects, the configuration information may include an indication of one or more configuration parameters already known to the UE) for selection by the UE, explicit configuration information for the UE to use to configure the UE, and/or the like.

In some aspects, the configuration information may indicate that the UE is to determine default beams and/or PL RSs for multiple component carriers in a multi-component carrier communication link. For example, the configuration information may indicate that the UE is to be configured to determine a default beam and/or a default PL RS for a first component carrier and apply the default beam and/or the default PL RS to multiple component carriers. In some aspects, the configuration information may indicate that the UE is to apply the default beam and/or the default PL RS to a second component carrier and/or one or more additional component carriers that are associated with a TRP that is also associated with the first component carrier.

As shown by reference number 410, the UE may configure the UE for communicating with the base station. In some aspects, the UE may configure the UE based at least in part on the configuration information. In some aspects, the UE may be configured to perform one or more operations described herein.

As shown by reference number 415, the UE may transmit, and the base station may receive, an indication of a capability of the UE to determine the default beam and/or the default PL RS and to apply the default beam and/or the default PL RS to the second beam without receiving explicit indications of a beam and/or a PL RS for the second beam. In some aspects, the UE may transmit the indication via RRC signaling, one or more MAC CEs, a physical uplink control channel (PUCCH) message, and/or the like.

As shown by reference number 420, the UE may receive information associated with determining a default beam and/or a default PL RS for a first component carrier. In some aspects, the information may include a first reference signal associated with a lowest control resource set (CORESET) identification (ID), a second reference signal associated with an active PDSCH, and/or the like. In some aspects, the first reference signal may include a QCL TypeD reference signal of a first TCI or QCL of a CORESET that has a lowest CORESET ID, the second reference signal may include a QCL TypeD reference signal of a second TCI or QCL of an active PDSCH TCI ID.

As shown by reference number 425, the UE may determine the default beam and/or the default PL RS for the first component carrier. In some aspects, the UE may determine the default beam and/or the default PL RS based at least in part on the information received from the base station as described with respect to reference number 420.

In some aspects, if the UE is configured to determine a default beam and/or a default PL RS for SRS (e.g., enableDefaultBeamPlForSRS is configured), and if a component carrier (e.g., a serving cell) is included in an applicable list of component carriers indicated by a higher layer parameter (e.g., simultaneousSpatial-UpdatedList-r16 or simultaneousSpatial-UpdatedListSecond-r16), when a spatial domain transmission filter is activated and/or updated for one or more semi-persistent or aperiodic SRS resources configured by a higher layer parameter (e.g., SRS-Resource) and/or indicated by a MAC CE for the component carrier (e.g., the serving cell), the spatial domain transmission filter may be applied for the one or more semi-persistent or the aperiodic SRS resources with the same SRS resource ID for all bandwidth parts in an indicated component carrier.

In some aspects, if a spatial domain transmission filter is simultaneously activated and/or updated for multiple serving cells in an applicable list of component carriers indicated (e.g., by simultaneousSpatial-UpdatedList-r16 or simultaneousSpatial-UpdatedListSecond-r16), the spatial domain transmission filter updated on a component carrier (g., the serving cell) with a lowest ID of the multiple serving cells may be applied to all serving cells in an applicable list of component carriers.

In some aspects, determining the default uplink beam and/or the default PL RS for the first component carrier includes determining the default uplink beam and/or the default PL RS for the first component carrier of the communication link based at least in part on a first QCL TypeD reference signal of a first TCI or QCL of a CORESET that has a lowest CORESET ID of component carriers associated with a same TRP. In some aspects, determining the default uplink beam and/or the default PL RS for the first component carrier may include determining the default uplink beam and/or the default PL RS for the first component carrier of the communication link based at least in part on a second QCL TypeD reference signal of a second TCI or QCL of an active PDSCH TCI ID associated with the same TRP.

In some aspects, a communication link between the UE and the base station may include a single DCI configuration. In some aspects, determining the default uplink beam and/or the default PL RS for the first component carrier may include determining the default uplink beam and/or the default PL RS for the first component carrier based at least in part on a QCL TypeD reference signal of a single TCI state of multiple TCI states that are mapped to a same TCI codepoint. In some aspects, the single TCI state may be mapped to multiple TCI states. The single TCI state may include a lowest TCI codepoint ID among TCI codepoints mapped to the multiple TCI states, a highest TCI codepoint ID among the TCI codepoints mapped to the multiple TCI states, a designated TCI codepoint ID of the TCI codepoints mapped to the multiple TCI states, and/or the like.

In some aspects, the UE may communicate using a multiple TRP (mTRP) configuration. The UE may determine the default uplink beam and/or the default PL RS per TRP associated with the mTRP configuration. In some aspects, the UE may communicate using the mTRP configuration and a multiple DCI (mDCI) mTRP configuration or a single DCI (sDCI) mTRP configuration.

Based at least in part on the UE communicating with the base station using an mDCI mTRP configuration, the UE may determine the default uplink beam and/or the default PL RS based at least in part on a QCL-TypeD reference signal of a TCI and/or QCL of a CORESET of the lowest CORESET ID of those associated with a TRP, or an active PDSCH TCI codepoint of those associated with the TRP (e.g., if no CORESET is configured). In some aspects, the UE may identify CORESET IDs that are associated with the TRP based at least in part on a CORESET pool index (e.g., CORESETPoolIndex).

Based at least in part on the UE communicating with the base station using an sDCI mTRP configuration, the UE may determine the default uplink beam and/or the default PL RS based at least in part on a QCL-TypeD reference signal of a TCI state of multiple TCI states that are mapped to a single TCI codepoint. The single TCI codepoint may have a highest TCI codepoint ID, a lowest TCI codepoint ID, or a special (e.g., associated with an indication) TCI codepoint ID among TCI codepoints that are mapped to multiple TCI states (e.g., two TCI states).

In some aspects, the UE may communicate using an mTRP configuration and may determine a default downlink beam per TRP. In some aspects, the UE may communicate using an mDCI mTRP configuration and may determine the default downlink beam per TRP based at least in part on a TCI and/or QCL of a lowest CORESET ID, among CORESET IDs associated with a same TRP identified by a CORESET pool index, in a latest monitored (e.g., a most recently monitored) slot. In some aspects, the UE may communicate using an sDCI mTRP configuration and may determine the default downlink beam per TRP based at least in part on a TCI state of multiple TCI states that are mapped to a same TCI codepoint. In some aspects, the TCI state of the multiple TCI states may have a lowest TCI codepoint ID among TCI codepoints that are mapped to multiple TCI states.

As shown by reference number 430, the UE may determine that one or more additional component carriers do not have a configured or indicated spatial relation and/or PL RS. For example, the UE may determine that a DCI did not explicitly indicate a beam (e.g., a spatial relation) and/or a PL RS to use for the second component carrier.

As shown by reference number 435, the UE may apply the default beam and/or the default PL RS to one or more of the additional component carriers (e.g., the second component carrier). In some aspects, the UE may apply the default beam and/or the default PL RS to the one or more of the additional component carriers based at least in part on the one or more of the additional component carriers carrier being indicated within an uplink component carrier list that indicates to apply the one or more of the default uplink beam or the PL RS to the one or more additional component carriers, based at least in part on a determination that the first component carrier and the one or more additional component carriers are associated with a same TRP, and/or the like.

In some aspects, for an SRS, a PUCCH, and/or a PUSCH of a second component carrier without a spatial relation (e.g., a configured and/or indicated spatial relation) and/or a PL RS (e.g., a configured and/or indicated PL RS), the UE may determine the default uplink beam and/or the default PL RS for the first component carrier (e.g., based at least in part on a QCL-TypeD reference signal of a TCI and/or QCL of a lowest CORESET ID) and apply the default uplink beam and/or the default PL RS to the second component carrier. If there is not a configured CORESET, the UE may determine the default uplink beam and/or the default PL RS based at least in part on a QCL-TypeD reference signal of an active PDSCH TCI and may apply the default uplink beam and/or the default PL RS to the second component carrier.

As shown by reference number 440, the UE may transmit via the one or more additional component carriers. For example, the UE may transmit a communication, such as an SRS, a PUCCH communication, and/or a PUSCH communication via the one or more additional component carriers based at least in part on the default beam and/or the default PL RS. In some aspects, the UE may configure a spatial relation and/or a spatial domain transmission filter for transmitting the communication based at least in part on the default beam. In some aspects, the UE may configure one or more transmission power control parameters based at least in part on the default PL RS.

In this way, the UE may determine a single default beam and/or default PL RS to apply to multiple component carriers to conserve computing, communication, and/or networking resources that may otherwise have been used to receive additional signaling from a base station, separately determine the default beams and/or default PL RSs for each component carrier, and/or the like.

As indicated above, FIG. 4 is provided as an example. Other examples may differ from what is described with regard to FIG. 4.

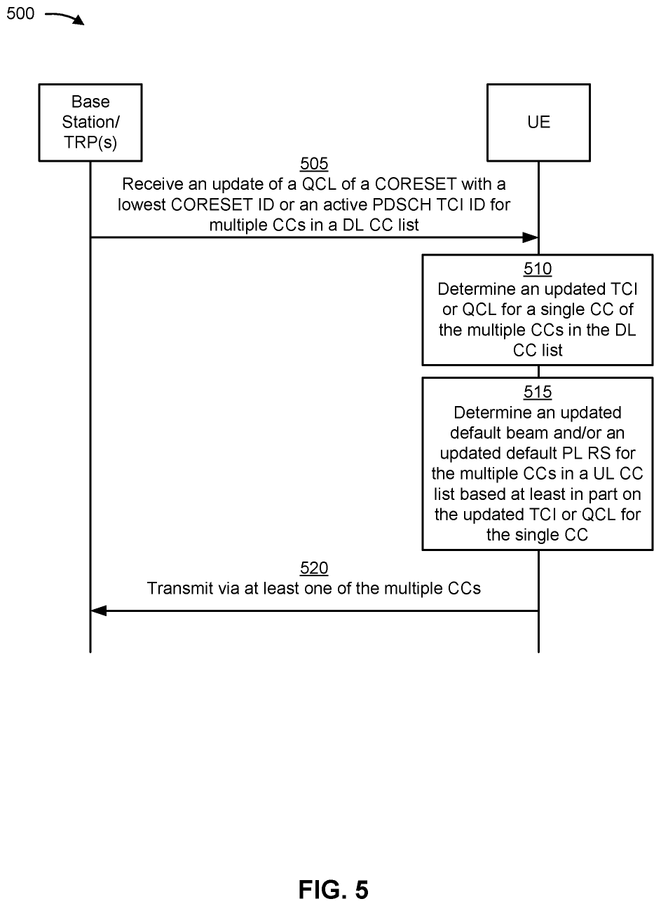

As shown in FIG. 5, and by reference number 505, a UE (e.g., UE 120) may receive, and a base station (e.g., base station 120) may transmit, an update of a TCI and/or QCL of a CORESET of the lowest CORESET ID or an active PDSCH TCI for multiple CCs in a downlink component carrier list. In some aspects, the UE may receive the update via a MAC CE.

As shown by reference number 510, the UE may determine an updated TCI or and/or QCL for a single component carrier of the multiple component carriers in the downlink component carrier list. As shown by reference number 515, the UE may determine an updated default beam and/or an updated default PL RS for the multiple component carriers in an uplink component carrier list based at least in part on the updated TCI and/or QCL for the single component carrier.

In some aspects, the TCI and/or the QCL of the lowest CORESET ID or active PDSCH TCI ID may be simultaneously updated (e.g., by one MAC CE) for multiple component carriers in a downlink component carrier list. In some of these aspects, the UE may determine an updated default uplink beam and/or an updated PL RS for multiple component carriers in an uplink component carrier list based at least in part on a QCL-TypeD reference signal of the updated TCI and/or the updated QCL of a lowest CORESET ID or an active PDSCH TCI ID for a single component carrier. In some aspects, the single component carrier may be have a lowest component carrier ID, a highest component carrier ID, or a special component carrier ID (e.g., associated with an indication) among component carriers that are identified in both of the downlink component carrier list and the uplink component carrier list. In some aspects, the single component carrier may be explicitly indicated (e.g., via a component carrier ID) via RRC signalling, one or more MAC CEs, DCI, and/or the like. In some aspects, simultaneous PDCCH and/or PDSCH beam updates for multiple component carrier may not be allowed.

In some aspects, the UE may communicate with the base station using an mTRP configuration and may receive a simultaneous update for the TCI and/or the QCL of the lowest CORESET ID or active PDSCH TCI ID (e.g., by one MAC CE) in an uplink component carrier list. In some aspects, the UE may determine the default uplink beam and/or the default PL RS for the first component carrier and apply the default uplink beam and/or the default PL RS to component carriers associated with a same TRP in an uplink component carrier list. The UE may determine that component carriers are associated with the same TRP based at least in part on CORESET pool indexes (e.g., CORESETPoolIndex) and/or a TCI, state order in the TCI, codepoint that is associated with the component carriers. In some aspects, the UE may ignore the default uplink beam and/or the default PL RS per TRP if a secondary TRP component carrier has no component carrier associated with the same TRP. In some aspects, the default uplink beam and or the default PL RS per TRP determined for one component carrier cannot be applied to other component carriers.

In some aspects, the UE may communicate using an mTRP configuration and may receive a simultaneous update for the TCI and/or the QCL of the lowest CORESET ID or active PDSCH TCI ID in a downlink component carrier list. In some of these aspects, the UE may determine an updated default downlink beam per TRP for a single component carrier and may apply the updated downlink beam to component carriers of a downlink component carrier list that are associated with a same TRP. In some aspects, the UE may identify component carriers associated with the same TRP based at least in part on a CORESET pool index (e.g., CORESETPoolIndex) or a same TCI state order in the TCI codepoint. In some aspects, the UE may ignore the default downlink beam per TRP if a secondary TRP component carrier has no component carrier associated with the same TRP. In some aspects, the default downlink beam per TRP determined for one component carrier cannot be applied to other component carriers.

As shown by reference number 520, the UE may transmit via at least one of the multiple component carriers. For example, the UE may transmit a communication, such as an SRS, a PUCCH communication, and/or a PDSCH communication via the one or more additional component carriers based at least in part on the updated default beam and/or the updated default PL RS. In some aspects, the UE may configure a spatial relation and/or a spatial domain transmission filter for transmitting the communication based at least in part on the updated default beam. In some aspects, the UE may configure one or more transmission power control parameters based at least in part on the updated default PL RS.

In this way, the UE may determine updates to single default beam and/or default PL RS to apply to multiple component carriers to conserve computing, communication, and/or networking resources that may otherwise have been used to receive additional signaling from a base station, separately determine the default beams and/or default PL RSs for each component carrier, and/or the like.

As indicated above, FIG. 5 is provided as an example. Other examples may differ from what is described with regard to FIG. 5.

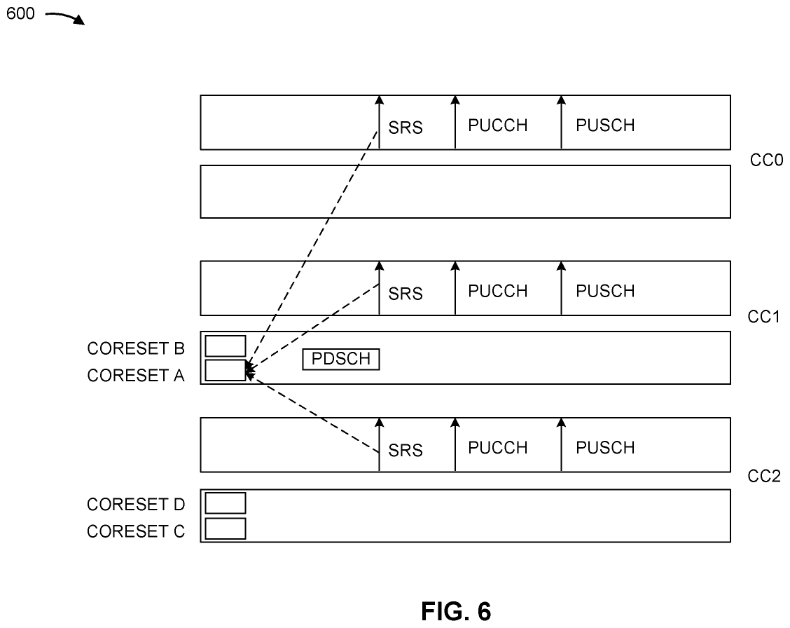

As shown in FIG. 6, a UE (e.g., UE 120) may determine a default beam and/or a default PL RS for a first component carrier (e.g., CC1) and apply the default beam and/or the default PL RS for additional component carriers (e.g., CC0 and CC2). In some aspects, the UE may apply the default beam and/or the default PL RS for the additional component carriers based at least in part on the additional component carriers being identified in an uplink component carrier list (e.g., simultaneousSpatial-UpdatedList-r16) of component carriers that identifies the first component carrier. Additionally, or alternatively, the UE may apply the default beam and/or the default PL RS for the additional component carriers based at least in part on the additional component carriers being identified in a downlink component carrier list (e.g., simultaneousDLTCI-UpdatedList-r16) that identifies the first component carrier.

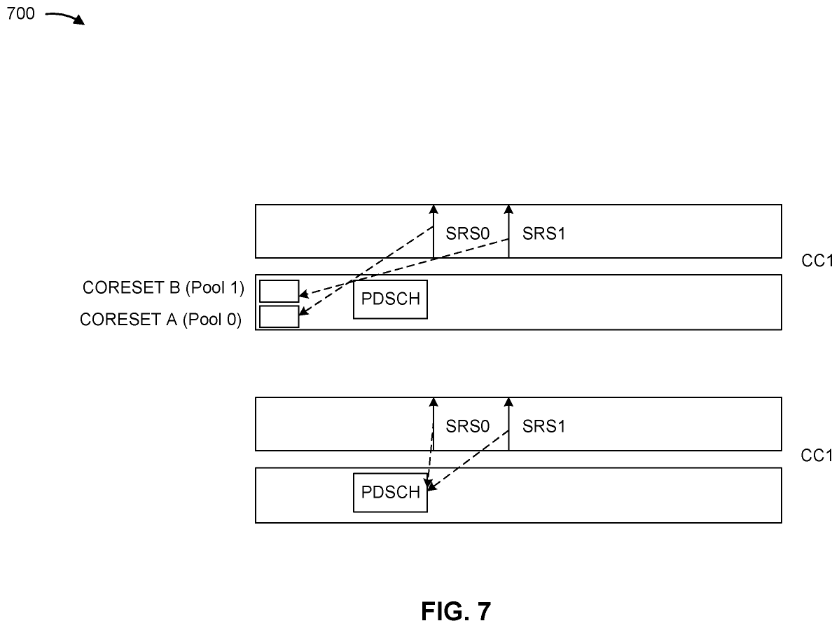

As shown in FIG. 7, a UE (e.g., UE 120) may communicate with multiple TRPs via one or more component carriers. As shown, a first SRS (SRS0) associated with a first TRP may be associated with a first CORESET (e.g., CORESET A), a second SRS (SRS1) associated with a second TRP may be associated with a second CORESET (e.g., CORESET B), and both of the first SRS and the second SRS may be associated with a PDSCH. In some aspects, a first TCI codepoint may be mapped to determining a default uplink beam and/or a default PL RS for the first SRS based at least in part on the first CORESET, a second TCI codepoint may be mapped to determining a default uplink beam and/or a default PL RS for the second SRS based at least in part on the second CORESET, a third TCI codepoint may be mapped to determining a default uplink beam and/or a default PL RS for the first SRS and the second SRS based at least in part on the PDSCH.

FIG. 8 is a diagram illustrating an example process 800 performed, for example, by a UE, in accordance with various aspects of the present disclosure. Example process 800 is an example where the UE (e.g., UE 120 and/or the like) performs operations associated with updating default beams and pathloss reference signals in a multi-component carrier communication link.

As shown in FIG. 8, in some aspects, process 800 may include determining one or more of a default uplink beam or a default PL RS for a first component carrier of a communication link (block 810). For example, the UE (e.g., using receive processor 258, transmit processor 264, controller/processor 280, memory 282, and/or the like) may determine one or more of a default uplink beam or a default PL RS for a first component carrier of a communication link, as described above.

As further shown in FIG. 8, in some aspects, process 800 may include applying the one or more of the default uplink beam or the default PL RS to a second component carrier of the communication link based at least in part on the second component carrier having no currently indicated PL RS or spatial relation (block 820). For example, the UE (e.g., using transmit processor 264, controller/processor 280, memory 282, and/or the like) may apply the one or more of the default uplink beam or the default PL RS to a second component carrier of the communication link based at least in part on the second component carrier having no currently indicated. PL RS or spatial relation, as described above.

Process 800 may include additional aspects, such as any single aspect or any combination of aspects described below and/or in connection with one or more other processes described elsewhere herein.

In a first aspect, application of the one or more of the default uplink beam or the default PL RS to the second component carrier of the communication link is based at least in part on the second component carrier being indicated within an uplink component carrier list that indicates to apply the one or more of the default uplink beam or the PL RS to the second component carrier of the communication link.

In a second aspect, alone or in combination with the first aspect, determination of the one or more of the default uplink beam or the default PL RS for the first component carrier of the communication link includes one or more of determining the one or more of the default uplink beam or the default PL RS for the first component carrier of the communication link based at least in part on a first reference signal associated with a lowest CORESET ID, or determining the one or more of the default uplink beam or the default PL RS for the first component carrier of the communication link based at least in part on a second reference signal associated with an active PDSCH.

In a third aspect, alone or in combination with one or more of the first and second aspects, the first reference signal includes a QCL TypeD reference signal of a first TCI or QCL of a CORESET that has a lowest CORESET ID, or the second reference signal comprises a QCL TypeD reference signal of a second TCI or QCL of an active PDSCH TCI ID.

In a fourth aspect, alone or in combination with one or more of the first through third aspects, process 800 includes receiving a first update, for multiple component carriers in a downlink component carrier list, for the first TCI or QCL of a CORESET that has the lowest CORESET ID, or receiving a second update, for the multiple component carriers in the downlink component carrier list, for the second TCI or QCL of an active PDSCH TCI ID.

In a fifth aspect, alone or in combination with one or more of the first through fourth aspects, reception of the first update includes receiving the first update via a first MAC CE, or reception of the second update includes receiving the second update via a second MAC CE.

In a sixth aspect, alone or in combination with one or more of the first through fifth aspects, process 800 includes determining one or more of an updated uplink beam or an updated PL RS for multiple component carriers in an uplink component carrier list based at least in part on an updated TCI or QCL for a single component carrier of the multiple component carriers in a downlink component carrier list.

In a seventh aspect, alone or in combination with one or more of the first through sixth aspects, the single component carrier of the multiple component carriers in the downlink component carrier list includes a component carrier having a lowest CORESET ID of component carriers that are in both of the downlink component carrier list and the uplink component carrier list, a component carrier having a highest CORESET ID of component carriers that are in both of the downlink component carrier list and the uplink component carrier list, or a designated component of component carriers that are in both of the downlink component carrier list and the uplink component carrier list.

In an eighth aspect, alone or in combination with one or more of the first through seventh aspects, process 800 includes receiving an indication of the single component carrier via RRC signaling, one or more MAC CEs, or DCI.

In a ninth aspect, alone or in combination with one or more of the first through eighth aspects, process 800 includes receiving an indication of the default uplink beam or the default PL RS for the first component carrier via a MAC CE, wherein the default uplink beam or the default PL RS is associated with an SRS resource; and transmitting one or more SRSs based at least in part on applying the default uplink beam or the default PL RS to multiple component carriers including the second component carrier.

In a tenth aspect, alone or in combination with one or more of the first through ninth aspects, the communication link includes a multiple TRP communication link with a multiple DCI configuration or a single DCI configuration, and application of the one or more of the default uplink beam or the default PL RS to a second component carrier is based at least in part on the first component carrier and the second component carrier being associated with a same TRP.

In an eleventh aspect, alone or in combination with one or more of the first through tenth aspects, determination of the one or more of the default uplink beam or the default PL RS for the first component carrier of the communication link includes one or more of: determining the one or more of the default uplink beam or the default PL RS for the first component carrier of the communication link based at least in part on a first QCL TypeD reference signal of a first TCI or QCL of a CORESET that has a lowest CORESET ID of component carriers associated with the same TRP, or determining the one or more of the default uplink beam or the default PL RS for the first component carrier of the communication link based at least in part on a second QCL TypeD reference signal of a second TCI or QCL of an active PDSCH TCI ID associated with the same TRP.

In a twelfth aspect, alone or in combination with one or more of the first through eleventh aspects, the communication link includes the single DCI configuration, and determination of the one or more of the default uplink beam or the default PL RS for the first component carrier includes determining the one or more of the default uplink beam or the default PL RS for the first component carrier based at least in part on a QCL TypeD reference signal of a single TCI state of multiple TCI states that are mapped to a same TCI codepoint.

In a thirteenth aspect, alone or in combination with one or more of the first through twelfth aspects, the TCI codepoint of the single TCI state is mapped with multiple TCI states and includes a lowest TCI codepoint ID among TCI codepoints mapped to the multiple TCI states, a highest TCI codepoint ID among the TCI codepoints mapped to the multiple TCI states, or a designated TCI codepoint ID of the TCI codepoints mapped to the multiple TCI states.

In a fourteenth aspect, alone or in combination with one or more of the first through thirteenth aspects, process 800 includes determining one or more of an updated uplink beam or an updated PL RS for the same TRP for multiple component carriers associated with the same TRP in an uplink component list, and determining that the multiple component carriers are associated with the same TRP based at least in part on having a same CORESET pool index or a same TCI state order in a codepoint.

In a fifteenth aspect, alone or in combination with one or more of the first through fourteenth aspects, process 800 includes determining a default downlink beam per TRP based at least in part on a TCI or QCL of a lowest CORESET ID, of the same TRP, in a most recently monitored slot, wherein the communication is linking includes a multiple DCI configuration.

In a sixteenth aspect, alone or in combination with one or more of the first through fifteenth aspects, process 800 includes determining a default downlink beam per TRP based at least in part on a single TCI state of multiple TCI states that are mapped to a same TCI codepoint that has a lowest TCI codepoint ID among TCI codepoints mapped to multiple TCI states.

In a seventeenth aspect, alone or in combination with one or more of the first through sixteenth aspects, process 800 includes determining one or more of an updated uplink beam or an updated PL RS for the same TRP for multiple component carriers associated with the same TRP in a downlink component list, and determining that the multiple component carriers are associated with the same TRP based at least in part on having a same CORESET pool index or a same TCI state order in a TCI codepoint.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

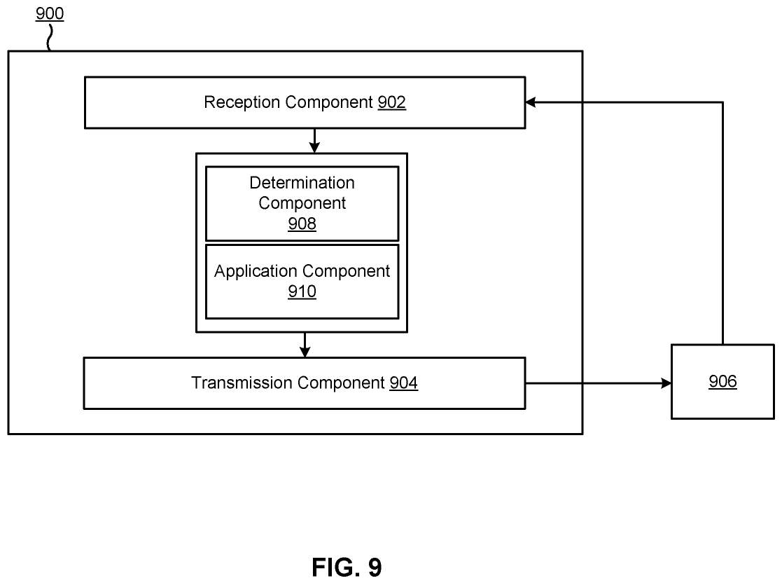

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include one or more of a determination component 908, or an application component 912, among other examples.

In some aspects, the apparatus 900 may be configured to perform one or more operations described herein in connection with FIGS. 4-7. Additionally or alternatively, the apparatus 900 may be configured to perform one or more processes described herein, such as process 800 of FIG. 8. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be collocated with the reception component 902 in a transceiver.

The reception component 902 may receive information associated with determining a default beam and/or a default PL RS for a first component carrier. The determination component 908 may determine one or more of a default uplink beam or a default PL RS for a first component carrier of a communication link. The application component may apply the one or more of the default uplink beam or the default PL RS to a second component carrier of the communication link based at least in part on the second component carrier having no currently indicated PL RS or spatial relation. The transmission component 904 may transmit an SRS, PUSCH, PUCCH and/or the like to the other apparatus 906.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
identifying one or more of a default uplink beam or a default pathloss reference signal (PL RS) for a first component carrier of a communication link; and
transmitting a communication via a second component carrier of the communication link based at least in part on application of the one or more of the default uplink beam or the default PL RS to a second component carrier of the communication link based at least in part on the second component carrier having no currently indicated PL RS or spatial relation.

2. The method of claim 1, wherein application of the one or more of the default uplink beam or the default PL RS to the second component carrier of the communication link is based at least in part on the second component carrier being indicated within an uplink component carrier list that indicates to apply the one or more of the default uplink beam or the PL RS to the second component carrier of the communication link.

3. The method of claim 1, wherein the one or more of the default uplink beam or the default PL RS for the first component carrier of the communication link are based at least in part on one or more of:
a first reference signal associated with a control resource set of a lowest control resource set identification, or
a second reference signal associated with an active physical downlink shared channel.

4. The method of claim 3, wherein the first reference signal comprises a quasi-co-location (QCL) TypeD reference signal of a first transmission configuration indicator (TCI) or QCL of a control resource set that has a lowest control resource set identification, or
wherein the second reference signal comprises a QCL TypeD reference signal of a second TCI or QCL of an active physical downlink shared channel TCI identification.

5. (canceled)

6. (canceled)

7. The method of claim 4, further comprising:
identifying one or more of an updated uplink beam or an updated PL RS for multiple component carriers in an uplink component carrier list based at least in part on an updated TCI or QCL for a single component carrier of the multiple component carriers in a downlink component carrier list.

8. The method of claim 7, wherein the single component carrier of the multiple component carriers in the downlink component carrier list comprises:
a component carrier having a lowest control resource set identification of component carriers that are in both of the downlink component carrier list and the uplink component carrier list,
a component carrier having a highest control resource set identification of component carriers that are in both of the downlink component carrier list and the uplink component carrier list, or
a designated component of component carriers that are in both of the downlink component carrier list and the uplink component carrier list.

9. (canceled)

10. (canceled)

11. The method of claim 1, wherein the communication link includes a multiple transmission and reception point (TRP) communication link with a multiple downlink control information (DCI) configuration or a single DCI configuration, and
wherein application of the one or more of the default uplink beam or the default PL RS to a second component carrier is based at least in part on the first component carrier and the second component carrier being associated with a same TRP.

12. The method of claim 11, wherein identification of the one or more of the default uplink beam or the default PL RS for the first component carrier of the communication link comprises one or more of:
identifying the one or more of the default uplink beam or the default PL RS for the first component carrier of the communication link based at least in part on a first quasi-co-location (QCL) TypeD reference signal of a first transmission configuration indicator (TCI) or QCL that has a lowest control resource set identification of component carriers associated with the same TRP, or
identifying the one or more of the default uplink beam or the default PL RS for the first component carrier of the communication link based at least in part on a second QCL TypeD reference signal of a second TCI or QCL of an active physical downlink shared channel associated with the same TRP.

13. The method of claim 11, wherein the communication link includes the single DCI configuration, and
wherein identification of the one or more of the default uplink beam or the default PL RS for the first component carrier comprises:
identifying the one or more of the default uplink beam or the default PL RS for the first component carrier based at least in part on a QCL TypeD reference signal of a single TCI state of multiple TCI states that are mapped to a same TCI codepoint.

14. The method of claim 13, wherein a TCI codepoint of the single TCI state is mapped with multiple TCI states and comprises:
a lowest TCI codepoint identification among TCI codepoints mapped to the multiple TCI states,
a highest TCI codepoint identification among the TCI codepoints mapped to the multiple TCI states, or
a designated TCI codepoint identification of the TCI codepoints mapped to the multiple TCI states.

15. The method of claim 11, further comprising:
identifying one or more of an updated uplink beam or an updated PL RS for the same TRP for multiple component carriers associated with the same TRP in an uplink component list, and
identifying the multiple component carriers as associated with the same TRP based at least in part on having a same control resource set pool index or a same TCI state order in a codepoint.

16. The method of claim 11, further comprising:
identifying a default downlink beam per TRP based at least in part on a TCI or QCL of a control resource set of a lowest control resource set identification, of the same TRP, in a most recently monitored slot,
wherein the communication link includes a multiple DCI configuration.

17. The method of claim 11, further comprising:
identifying a default downlink beam per TRP based at least in part on a single TCI state of multiple TCI states that are mapped to a same TCI codepoint that has a lowest TCI codepoint identification among TCI codepoints mapped to multiple TCI states.

18. The method of claim 11, further comprising:
identifying one or more of an updated uplink beam or an updated PL RS for the same TRP for multiple component carriers associated with the same TRP in a downlink component list, and
identifying the multiple component carriers as associated with the same TRP based at least in part on having a same control resource set pool index or a same TCI state order in a TCI codepoint.

19. A user equipment (UE) for wireless communication, comprising:
a memory; and
one or more processors operatively coupled to the memory, the memory and the one or more processors configured to:
identify one or more of a default uplink beam or a default pathloss reference signal (PL RS) for a first component carrier of a communication link; and
transmit a communication via a second component carrier of the communication link based at least in part on application of the one or more of the default uplink beam or the default PL RS to a second component carrier of the communication link based at least in part on the second component carrier having no currently indicated PL RS or spatial relation.

20. The UE of claim 19, wherein application of the one or more of the default uplink beam or the default PL RS to a second component carrier of the communication link is based at least in part on the second component carrier being indicated within an uplink component carrier list that indicates to apply the one or more of the default uplink beam or the PL RS to a second component carrier of the communication link.

21. The UE of claim 19, wherein the one or more of the default uplink beam or the default PL RS for the first component carrier of the communication link are based at least in part on one or more of:
a first reference signal associated with a lowest control resource set identification, or
a second reference signal associated with an active physical downlink shared channel.

22. The UE of claim 21, wherein the first reference signal comprises a quasi-co-location (QCL) TypeD reference signal of a first transmission configuration indicator (TCI) or QCL that has a lowest control resource set identification, or
wherein the second reference signal comprises a QCL TypeD reference signal of a second TCI or QCL of an active physical downlink shared channel TCI identification.

23. (canceled)

24. (canceled)

25. The UE of claim 22, wherein the one or more processors are further configured to:
identify one or more of an updated uplink beam or an updated PL RS for multiple component carriers in an uplink component carrier list based at least in part on an updated TCI or QCL for a single component carrier of the multiple component carriers in a downlink component carrier list.

26. The UE of claim 25, wherein the single component carrier of the multiple component carriers in the downlink component carrier list comprises:
a component carrier having a lowest control resource set identification of component carriers that are in both of the downlink component carrier list and the uplink component carrier list,
a component carrier having a highest control resource set identification of component carriers that are in both of the downlink component carrier list and the uplink component carrier list, or
a designated component of component carriers that are in both of the downlink component carrier list and the uplink component carrier list.

27. (canceled)

28. (canceled)

29. The UE of claim 19, wherein the communication link includes a multiple transmission and reception point (TRP) communication link with a multiple downlink control information (DCI) configuration or a single DCI configuration, and
wherein application of the one or more of the default uplink beam or the default PL RS to a second component carrier is based at least in part on the first component carrier and the second component carrier being associated with a same TRP.

30. The UE of claim 29, wherein identification of the one or more of the default uplink beam or the default PL RS for the first component carrier of the communication link comprises one or more of:
identification of the one or more of the default uplink beam or the default PL RS for the first component carrier of the communication link based at least in part on a first quasi-co-location (QCL) TypeD reference signal of a first transmission configuration indicator (TCI) or QCL of a control resource set that has a lowest control resource set identification of component carriers associated with the same TRP, or
identification of the one or more of the default uplink beam or the default PL RS for the first component carrier of the communication link based at least in part on a second QCL TypeD reference signal of a second TCI or QCL of an active physical downlink shared channel TCI identification associated with the same TRP.

31. The UE of claim 29, wherein the communication link includes the single DCI configuration, and
wherein identification of the one or more of the default uplink beam or the default PL RS for the first component carrier comprises:
identification of the one or more of the default uplink beam or the default PL RS for the first component carrier based at least in part on a QCL TypeD reference signal of a single TCI state of multiple TCI states that are mapped to a same TCI codepoint.

32. The UE of claim 31, wherein the TCI codepoint of the single TCI state is mapped with multiple TCI states and comprises:
a lowest TCI identification among TCI codepoints mapped to the multiple TCI states,
a highest TCI identification among the TCI codepoints mapped to the multiple TCI states, or
a designated TCI identification of the TCI codepoints mapped to the multiple TCI states.

33. The UE of claim 29, wherein the one or more processors are further configured to:
identify one or more of an updated uplink beam or an updated PL RS for the same TRP for multiple component carriers associated with the same TRP in an uplink component list, and
identify the multiple component carriers as associated with the same TRP based at least in part on having a same control resource set pool index or a same TCI state order in a codepoint.

34. The UE of claim 29, wherein the one or more processors are further configured to:
identify a default downlink beam per TRP based at least in part on a TCI or QCL of a control resource set of a lowest control resource set identification, of the same TRP, in a most recently monitored slot,
wherein the communication link includes a multiple DCI configuration.

35. The UE of claim 29, wherein the one or more processors are further configured to:
identify a default downlink beam per TRP based at least in part on a single TCI state of multiple TCI states that are mapped to a same TCI codepoint that has a lowest TCI codepoint identification among TCI codepoints mapped to multiple TCI states.

36. The UE of claim 29, wherein the one or more processors are further configured to:
identify one or more of an updated uplink beam or an updated PL RS for the same TRP for multiple component carriers associated with the same TRP in a downlink component list, and
identify the multiple component carriers as associated with the same TRP based at least in part on having a same control resource set pool index or a same TCI state order in a codepoint.

37. A non-transitory computer-readable medium storing one or more instructions for wireless communication, the one or more instructions comprising:
one or more instructions that, when executed by one or more processors of a user equipment, cause the one or more processors to:
identify one or more of a default uplink beam or a default pathloss reference signal (PL RS) for a first component carrier of a communication link; and
transmit a communication via a second component carrier of the communication link based at least in part on application of the one or more of the default uplink beam or the default PL RS to a second component carrier of the communication link based at least in part on the second component carrier having no currently indicated PL RS or spatial relation.

38. The non-transitory computer-readable medium of claim 37, wherein application of the one or more of the default uplink beam or the default PL RS to a second component carrier of the communication link is based at least in part on the second component carrier being indicated within an uplink component carrier list that indicates to apply the one or more of the default uplink beam or the PL RS to a second component carrier of the communication link.

39. The non-transitory computer-readable medium of claim 37, wherein the one or more of the default uplink beam or the default PL RS for the first component carrier of the communication link are based at least in part on one or more of:
a first reference signal associated with a lowest control resource set identification, or
a second reference signal associated with an active physical downlink shared channel.

40-54. (canceled)

55. An apparatus for wireless communication, comprising:
means for identifying one or more of a default uplink beam or a default pathloss reference signal (PL RS) for a first component carrier of a communication link; and
means for transmitting a communication via a second component carrier of the communication link based at least in part on application of the one or more of the default uplink beam or the default PL RS to a second component carrier of the communication link based at least in part on the second component carrier having no currently indicated PL RS or spatial relation.

56. The apparatus of claim 0, wherein application of the one or more of the default uplink beam or the default PL RS to a second component carrier of the communication link is based at least in part on the second component carrier being indicated within an uplink component carrier list that indicates to apply the one or more of the default uplink beam or the PL RS to a second component carrier of the communication link.

57. The apparatus of claim 0, wherein the one or more of the default uplink beam or the default PL RS for the first component carrier of the communication link are based at least in part on one or more of:
means for a first reference signal associated with a control resource set of a lowest control resource set identification, or p1 means for a second reference signal associated with an active physical downlink shared channel.

58. The apparatus of claim 0, wherein the first reference signal comprises a quasi-co-location (QCL) TypeD reference signal of a first transmission configuration indicator (TCI) or QCL of a control resource set that has a lowest control resource set identification, or
wherein the second reference signal comprises a QCL TypeD reference signal of a second TCI or QCL of an active physical downlink shared channel TCI identification.

59-72. (canceled)
